(19) United States
(12) Patent Application Publication
(10) Pub. No.: US 2025/0323870 A1
(43) Pub. Date: Oct. 16, 2025

(54) SYSTEMS AND METHODS FOR GROUPING AND SCHEDULING OF SOCKET OUTLETS

(71) Applicant: Honeywell International Inc., Charlotte, NC (US)

(72) Inventors: Jayaprakash Meruva, Bangalore (IN); Vijay Raju, Bangalore (IN); Nitant Kulshrestha, Bhopal (IN)

(21) Appl. No.: 18/748,094

(22) Filed: Jun. 20, 2024

(30) Foreign Application Priority Data
Apr. 10, 2024 (IN) 202411029198

(51) Int. Cl. H04L 47/193; H04L 69/16

(52) U.S. Cl. CPC H04L 47/193; H04L 69/162

(57) ABSTRACT

Various embodiments described herein relate to providing and/or employing a system and a method for controlling operations of socket outlets across a plurality of facilities. In this regard, at least one group of socket outlets from a plurality of socket outlets is generated. The plurality of socket outlets is associated with a plurality of facilities and the socket outlets are logically grouped based on data associated with a plurality of assets. At least one schedule is generated corresponding to the at least one group of socket outlets and the at least one schedule is split among the plurality of facilities based on the generated group of socket outlets. Furthermore, the at least one schedule is executed at the plurality of facilities, and at least one operation of the at least one group of socket outlets is controlled based on the at least one schedule.

### TECHNICAL FIELD

The present disclosure generally relates to electric sockets in a plurality of facilities. More particularly, the present disclosure relates to grouping and scheduling of socket outlets for monitoring and controlling plug-in assets across the plurality of facilities.

### BACKGROUND

In a facility such as a building, there is a building management system which monitors and controls assets such as, but not limited to boilers, chillers, HVAC equipment, AHUs, etc. However, the building management system generally do not offer a capability to monitor the plug-in assets or plug-in loads. The plug-in assets are electrical equipment that is operated by being connected to socket outlets (alternatively, referred to as plug points and receptacles) via a plug. The socket outlets supply electric power to the plug-in assets. Generally, energy consumption by assets such as boilers, chillers, HVAC equipment, etc. is of major concern since these assets consume a considerable amount of energy. That is, such assets are generally energy intensive. However, energy consumption by the plug-in assets such as printers, microwave oven, table lamps, refrigerator, etc. often go unnoticed or neglected as these are low energy consuming assets. Approximately, over 25 percent of the energy consumed by a typical commercial building is related to the plug-in assets. Therefore, there is a need to monitor the energy consumption by the plug-in assets and take appropriate energy saving measures.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments, in which:

FIG. 1 illustrates an exemplary networked computing system environment, in accordance with one or more embodiments of the present disclosure;

FIG. 2 illustrates a schematic block diagram of a framework of an IoT platform of the networked computing system, in accordance with one or more embodiments of the present disclosure;

FIG. 3 illustrates a layered architecture of a system for controlling operations of the socket outlets, in accordance with one or more embodiments of the present disclosure;

FIG. 4 illustrates an exemplary block diagram of a sample group of the socket outlets, in accordance with one or more embodiments of the present disclosure;

FIG. 5A is a flowchart illustrating example operations of controlling the socket outlets, in accordance with one or more embodiments of the present disclosure;

FIG. 5B is a flowchart illustrating example operations of controlling the socket outlets, in accordance with another embodiment of the present disclosure;

FIG. 6 is a flowchart illustrating example operations of generating a schedule corresponding to the group of socket outlets, in accordance with one or more embodiments of the present disclosure;

FIG. 7 is a flowchart illustrating example operations of transmitting control commands to the group of socket outlets, in accordance with one or more embodiments of the present disclosure; and

FIG. 8 is an exemplary illustration of dashboard visualization data via a visualization interface, in accordance with one embodiment of the present disclosure.

FIG. 9 is an exemplary illustration of dashboard visualization data via the visualization interface, in accordance with another embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### SUMMARY OF THE INVENTION

The details of some embodiments of the subject matter described in this specification are set forth in the accompanying drawings and the description below. Other features, aspects, and advantages of the subject matter will become apparent from the description, the drawings, and the claims.

In accordance with an embodiment of the present disclosure, a system for controlling operations of socket outlets across a plurality of facilities is described. The system comprises a cloud-based server. The cloud-based server comprising a processor and a memory storing program instructions which, when executed by the processor, cause the processor to generate at least one group of socket outlets from a plurality of socket outlets associated with a plurality of facilities, wherein the socket outlets are logically grouped based on data associated with a plurality of assets. The processor is further configured to generate at least one schedule corresponding to the at least one group of socket outlets. The processor is further configured to split the at least one schedule among the plurality of facilities based on the generated group of socket outlets. The processor is further configured to execute, at the plurality of facilities, the at least one schedule corresponding to the at least one group of socket outlets. The processor is further configured to control at least one operation of the at least one group of socket outlets based on the at least one schedule.

In accordance with another embodiment of the present disclosure, a system for controlling operations of socket outlets across a facility is described. The system comprising a gateway controller and a memory storing program instructions which, when executed by the gateway controller, cause the gateway controller to receive, from a cloud-based server, at least one schedule corresponding to a set of socket outlets from at least one group of socket outlets, wherein the set of socket outlets corresponds to a facility of a plurality of facilities. The cloud-based server is configured to generate the at least one group of socket outlets from a plurality of socket outlets associated with the plurality of facilities, wherein the socket outlets are logically grouped based on data associated with a plurality of assets. The cloud-based server is further configured to generate the at least one schedule corresponding to the at least one group of socket outlets. The cloud-based server is further configured to split the at least one schedule among the plurality of facilities based on the generated group of socket outlets. The gateway controller is further configured to execute, at the facility, the at least one schedule corresponding to the set of socket outlets. The gateway controller is further configured to control at least one operation of the set of socket outlets based on the at least one schedule.

According to an aspect of the present disclosure, a method for controlling operations of socket outlets across a plurality of facilities is described. The method includes steps of generating at least one group of socket outlets from a plurality of socket outlets associated with a plurality of facilities, wherein the socket outlets are logically grouped based on data associated with a plurality of assets, generating at least one schedule corresponding to the at least one group of socket outlets, splitting the at least one schedule among the plurality of facilities based on the generated group of socket outlets, executing, at the plurality of facilities, the at least one schedule corresponding to the at least one group of socket outlets, and controlling at least one operation of the at least one group of socket outlets based on the at least one schedule.

The above summary is provided merely for purposes of providing an overview of one or more exemplary embodiments described herein so as to provide a basic understanding of some aspects of the present disclosure. Accordingly, it will be appreciated that the above-described embodiments are merely examples and should not be construed to narrow the scope of the present disclosure in any way. It will be appreciated that the scope of the present disclosure encompasses many potential embodiments in addition to those summarized herein, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### DETAILED DESCRIPTION

Reference will now be made in detail to embodiments, examples of which are illustrated in the accompanying drawings. In the following detailed description, numerous specific details are set forth to provide a thorough understanding of the described embodiments. However, it will be apparent to one of ordinary skill in the art that the described embodiments may be practiced without these specific details. Well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” according to one embodiment,” and the like generally mean that a particular feature, structure, or characteristic following the phrase can be included in at least one embodiment of the present disclosure and can be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature can be optionally included in some example embodiments, or it can be excluded.

Often, facilities include several sockets (alternatively, referred to as plug points and receptacles) to connect various assets in the facilities. In this regard, the sockets can be wireless sockets capable of wirelessly receiving instructions from an on-premises system or a remote system, and wirelessly transmitting information about the plug-in assets (or plug-in loads) over a network. For having such capabilities, the wireless sockets are finding increased usage in household, commercial, and industrial environments. However, a typical facility often includes many sockets, and it becomes challenging to monitor each socket individually and control its operations. Further, it is difficult to monitor the energy consumption by each plug-in asset. Also, the plug-in assets are not operational always. Operation of the plug-in assets is dependent on several factors such as such as occupancy hours of users at the facility, timings, etc. That is, at times, they may be operational or non-operational based on such factors. For instance, there can be a plug-in asset such as a printer at every floor in the facility. These printers are connected to socket outlets. These printers are used by employees on weekdays during office hours. However, these printers are not in use outside of office hours and on weekends. So, it is difficult to switch OFF each printer manually and monitor the energy consumption.

Further, at times, multiple logical groups of socket outlets may be created so that the grouped socket outlets may be controlled easily as compared to controlling each socket outlet individually. However, these socket outlets may be grouped and scheduled at facility level only. Hence, it is difficult to implement common schedules across multiple facilities at a portfolio level as it requires respective facility operators to access individual building supervisor station and create same groups and schedules separately across the multiple facilities. Further, if there would be a change in these common schedules, this needs to be communicated again to the respective facility operators and repeat manually the change in all the facility level supervisor stations. This makes a portfolio operator to repeat the same task again and again. This is a time-consuming activity. Alternatively, there may be dependence on the respective facility operators to perform these operations in all facility level supervisor stations. Another challenge is that the individual facilities are not connected, therefore it is not possible to combine socket outlets from different facilities to have common groups and schedules. Accordingly, in such scenarios where the plug-in loads are used intermittently, such as during a particular time in a day or a week or a month, monitoring the energy consumption of the plug-in assets becomes challenging.

Thus, to address the above challenges, there is a need for monitoring and controlling the socket outlets at a portfolio level by grouping and scheduling the socket outlets across multiple facilities. Also, there is a need for monitoring the power usage of the plug-in assets and taking appropriate energy conservation measures to increase energy efficiency of the multiple facilities.

According to various embodiments, the present invention aims to implement a cloud solution for grouping, scheduling (such as creating or modifying schedules), and controlling the socket outlets across multiple facilities at a portfolio level. Various factors considered for grouping of the socket outlets, may be, but not limited to a type of the plug-in asset, power consumption of the plug-in asset, operational context, location of the plug-in asset, etc. For example, at facility A and facility B, a group of socket outlets connected to printers is created. Then a schedule is created that indicates the group of socket outlets connected to the printers will remain on from 12 AM to 7 PM from Monday to Friday. This schedule will be split to facility A and facility B and executed at respective facilities A and B. However, if it is noted that there is low occupancy on the floors during lunch time, say between 1 PM to 2 PM. Then the schedule will be created accordingly and the power consumption by the group of socket outlets connected to printers is managed. Further, if any employee has to use the printer outside the scheduled timings, he/she may manually switch on the printer. This will increase the flexibility of the system. Further, the present invention displays collective or granular information regarding power usage across the multiple facilities and sets alerts related to the power usage. This results in gaining actionable insights corresponding to the plug-in assets across multiple facilities, saving the energy consumed by the plug-in assets at a granular level, and identifying energy saving opportunities. Hence, the energy efficiency of the multiple facilities would be optimized. This also results in increasing productivity of personnel such as, but not limited to portfolio operators and/or facility operators significantly and the efforts are drastically reduced.

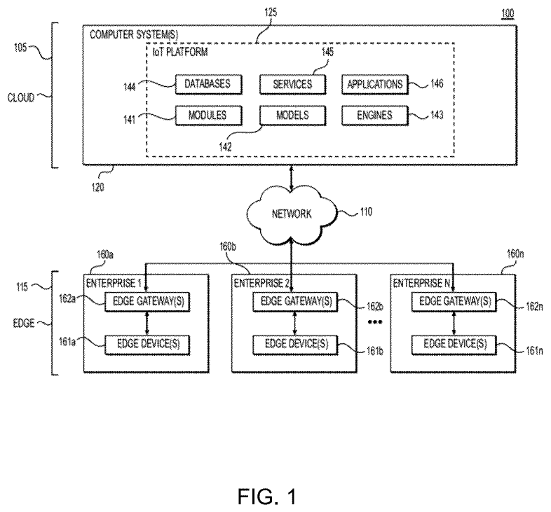

FIG. 1 illustrates an exemplary networked computing system environment 100, according to the present disclosure. As shown in FIG. 1, networked computing system environment 100 is organized into a plurality of layers including a cloud 105 (e.g., cloud layer 105), a network 110 (e.g., network layer 110), and an edge 115 (e.g., edge layer 115). As detailed further below, components of the edge 115 such as electric sockets are in communication with components of the cloud 105 via network 110.

In various embodiments, network 110 is any suitable network or combination of networks and supports any appropriate protocol suitable for communication of data to and from components of the cloud 105 and between various other components in the networked computing system environment 100 (e.g., components of the edge 115). According to various embodiments, network 110 includes a public network (e.g., the Internet), a private network (e.g., a network within an organization), or a combination of public and/or private networks. According to various embodiments, network 110 is configured to provide communication between various components depicted in FIG. 1. According to various embodiments, network 110 comprises one or more networks that connect devices and/or components in the network layout to allow communication between the devices and/or components. For example, in one or more embodiments, the network 110 is implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 110 is implemented using cellular networks, satellite, licensed radio, or a combination of cellular, satellite, licensed radio, and/or unlicensed radio networks.

Components of the cloud 105 include one or more computer systems 120 that form a so-called “Internet-of-Things” or “IoT” platform 125. It should be appreciated that “IoT platform” is an optional term describing a platform connecting any type of Internet-connected device, and should not be construed as limiting on the types of computing systems useable within the IoT platform 125. In particular, in various embodiments, computer systems 120 includes any type or quantity of one or more processors and one or more data storage devices comprising memory for storing and executing applications or software modules of networked computing system environment 100. In one embodiment, the processors and data storage devices are embodied in server-class hardware, such as enterprise-level servers. For example, in an embodiment, the processors and data storage devices comprise any type or combination of application servers, communication servers, web servers, super-computing servers, database servers, file servers, mail servers, proxy servers, and/virtual servers. Further, the one or more processors are configured to access the memory and execute processor-readable instructions, which when executed by the processors configures the processors to perform a plurality of functions of the networked computing system environment 100.

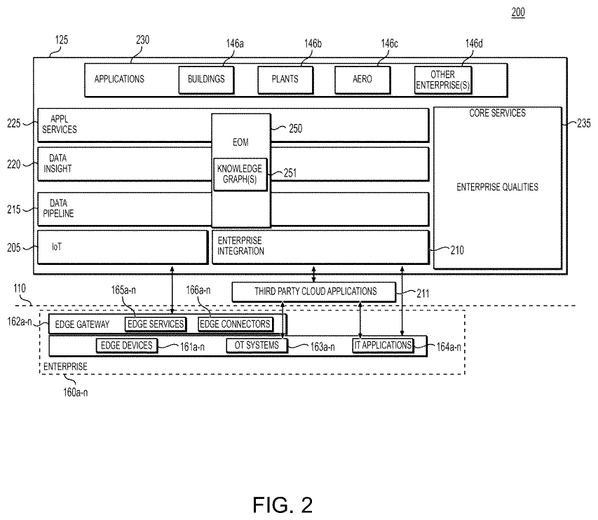

Computer systems 120 further include one or more software components of the IoT platform 125. For example, in one or more embodiments, the software components of computer systems 120 include one or more software modules to communicate with user devices and/or other computing devices through network 110. For example, in one or more embodiments, the software components include one or more modules 141, models 142, engines 143, databases 144, services 145, and/or applications 146, which may be stored in/by the computer systems 120 (e.g., stored on the memory), as detailed with respect to FIG. 2 below. According to various embodiments, the one or more processors are configured to utilize the one or more modules 141, models 142, engines 143, databases 144, services 145, and/or applications 146 when performing various methods described in this disclosure.

Accordingly, in one or more embodiments, computer systems 120 execute a cloud computing platform (e.g., IoT platform 125) with scalable resources for computation and/or data storage, and may run one or more applications on the cloud computing platform to perform various computer-implemented methods described in this disclosure. In some embodiments, some of the modules 141, models 142, engines 143, databases 144, services 145, and/or applications 146 are combined to form fewer modules, models, engines, databases, services, and/or applications. In some embodiments, some of the modules 141, models 142, engines 143, databases 144, services 145, and/or applications 146 are separated into separate, more numerous modules, models, engines, databases, services, and/or applications. In some embodiments, some of the modules 141, models 142, engines 143, databases 144, services 145, and/or applications 146 are removed while others are added.

The computer systems 120 are configured to receive data from other components (e.g., components of the edge 115) of networked computing system environment 100 via network 110. Computer systems 120 are further configured to utilize the received data to produce a result. According to various embodiments, information indicating the result is transmitted to users via user computing devices over network 110. In some embodiments, the computer systems 120 is a server system that provides one or more services including providing the information indicating the received data and/or the result(s) to the users. According to various embodiments, computer systems 120 are part of an entity which include any type of company, organization, or institution that implements one or more IoT services. In some examples, the entity is an IoT platform provider.

Components of the edge 115 include one or more enterprises 160 a-160 n each including one or more edge devices 161 a-161 n and one or more edge gateways 162 a-162 n. For example, a first enterprise 160 a includes first edge devices 161 a and first edge gateways 162 a, a second enterprise 160 b includes second edge devices 161 b and second edge gateways 162 b, and an nth enterprise 160 n includes nth edge devices 161 n and nth edge gateways 162 n. As used herein, enterprises 160 a-160 n represent any type of entity, facility, or vehicle, such as, for example, residential complex, factory, warehouse, transportation hub, distribution center, airport premises, hospital, data center, commercial building, government building, institutional building, monument, IT park, corporate office, tourist place, manufacturing plant, real estate facility, laboratory, oil and gas facility, or any other type of entity, facility, and/or entity that includes any number of local devices.

According to various embodiments, the edge devices 161 a-161 n represent any of a variety of different types of devices that may be found within the enterprises 160 a-160 n. Edge devices 161 a-161 n are any type of device configured to access network 110, or be accessed by other devices through network 110, such as via an edge gateway 162 a-162 n. According to various embodiments, edge devices 161 a-161 n are “IoT devices” which include any type of network-connected (e.g., Internet-connected) device. For example, in one or more embodiments, the edge devices 161 a-161 n include plug-in assets such as computers, monitors, laptop docking stations, printers, scanners, modems, routers, charging stations, ovens, refrigerators, table lamps, fans, lights, heaters, and/or any other devices that are connected to the network 110 for collecting, sending, and/or receiving information. Each edge device 161 a-161 n includes, or is otherwise in communication with, one or more controllers for selectively controlling a respective edge device 161 a-161 n and/or for sending/receiving information between the edge devices 161 a-161 n and the cloud 105 via network 110. With reference to FIG. 2, in one or more embodiments, the edge 115 include operational technology (OT) systems 163 a-163 n and information technology (IT) applications 164 a-164 n of each enterprise 161 a-161 n. The OT systems 163 a-163 n include hardware and software for detecting and/or causing a change, through the direct monitoring and/or control of industrial equipment (e.g., edge devices 161 a-161 n), assets, processes, and/or events. The IT applications 164 a-164 n includes network, storage, and computing resources for the generation, management, storage, and delivery of data throughout and between organizations.

The edge gateways 162 a-162 n include devices for facilitating communication between the edge devices 161 a-161 n and the cloud 105 via network 110. For example, the edge gateways 162 a-162 n include one or more communication interfaces for communicating with the edge devices 161 a-161 n and for communicating with the cloud 105 via network 110. According to various embodiments, the communication interfaces of the edge gateways 162 a-162 n include one or more cellular radios, Bluetooth, WiFi, near-field communication radios, Ethernet, or other appropriate communication devices for transmitting and receiving information. According to various embodiments, multiple communication interfaces are included in each gateway 162 a-162 n for providing multiple forms of communication between the edge devices 161 a-161 n, the gateways 162 a-162 n, and the cloud 105 via network 110. For example, in one or more embodiments, communication are achieved with the edge devices 161 a-161 n and/or the network 110 through wireless communication (e.g., WiFi, radio communication, etc.) and/or a wired data connection (e.g., a universal serial bus, an onboard diagnostic system, etc.) or other communication modes, such as a local area network (LAN), wide area network (WAN) such as the Internet, a telecommunications network, a data network, or any other type of network.

According to various embodiments, the edge gateways 162 a-162 n also include a processor and memory for storing and executing program instructions to facilitate data processing. For example, in one or more embodiments, the edge gateways 162 a-162 n are configured to receive data from the edge devices 161 a-161 n and process the data prior to sending the data to the cloud 105. Accordingly, in one or more embodiments, the edge gateways 162 a-162 n include one or more software modules or components for providing data processing services and/or other services or methods of the present disclosure. With reference to FIG. 2, each edge gateway 162 a-162 n includes edge services 165 a-165 n and edge connectors 166 a-166 n. According to various embodiments, the edge services 165 a-165 n include hardware and software components for processing the data from the edge devices 161 a-161 n. According to various embodiments, the edge connectors 166 a-166 n include hardware and software components for facilitating communication between the edge gateway 162 a-162 n and the cloud 105 via network 110, as detailed above. In some cases, any of edge devices 161 a-n, edge connectors 166 a-n, and edge gateways 162 a-n have their functionality combined, omitted, or separated into any combination of devices. In other words, an edge device and its connector and gateway need not necessarily be discrete devices.

FIG. 2 illustrates a schematic block diagram of a framework 200 of an IoT platform 125, according to an aspect of the present disclosure. The IoT platform 125 is provided for enterprise management that uses real-time data models and visual analytics to deliver intelligent actionable recommendations corresponding to energy conservation techniques corresponding to the plug-in assets or the plug-in loads for sustained peak performance of the enterprises 160 a-160 n. The IoT platform 125 is an extensible platform that may be deployed in any cloud or data center environment for providing an enterprise-wide, top to bottom view, displaying status of processes, assets, people, and safety. Further, the IoT platform 125 supports end-to-end capability to execute digital twins against process data and to translate the output into actionable insights and/or intelligent actions, using the framework 200, detailed further below.

As shown in FIG. 2, the framework 200 of the IoT platform 125 comprises a number of layers including, for example, an IoT layer 205, an enterprise integration layer 210, a data pipeline layer 215, a data insight layer 220, an application services layer 225, and an applications layer 230. The IoT platform 125 also includes a core services layer 235 and an extensible object model (EOM) 250 comprising one or more knowledge graphs 251. For example, each layer 205-235 may include one or more of the modules 141, models 142, engines 143, databases 144, services 145, applications 146, or combinations thereof. In some embodiments, the layers 205-235 may be combined to form fewer layers. In some embodiments, some of the layers 205-235 may include sub-layers.

The IoT platform 125 is a model-driven architecture. Thus, the EOM 250 is configured to communicate with each layer 205-230 to contextualize site data of the enterprises 160 a-160 n using the knowledge graphs 251 where the one or more assets (e.g., edge devices 161 a-161 n) and processes of the enterprises 160 a-160 n are modeled. The knowledge graphs 251 define a collection of nodes and links that describe real-world connections that enable smart systems. As used herein, a knowledge graph 251: (i) describes real-world entities (e.g., edge devices 161 a-161 n) and their interrelations organized in a graphical interface; (ii) defines possible classes and relations of entities in a schema; (iii) enables interrelating arbitrary entities with each other; and (iv) covers various topical domains. In other words, the knowledge graphs 251 define large networks of entities (e.g., edge devices 161 a-161 n), semantic types of the entities, properties of the entities, and relationships between the entities. Thus, the knowledge graphs 251 describe a network of “things” that are relevant to a specific domain or to an enterprise or organization. Knowledge graphs 251 are not limited to abstract concepts and relations, but can also contain instances of objects, such as, for example, documents and datasets. In some embodiments, the knowledge graphs 251 may include resource description framework (RDF) graphs. As used herein, a “RDF graph” is a graph data model that describes the semantics, or meaning, of information. The RDF graph can also represent metadata (e.g., data that describes data). Knowledge graphs 251 can also include a semantic object model. The semantic object model is a subset of a knowledge graph 251 that defines semantics for the knowledge graph 251. For example, the semantic object model defines the schema for the knowledge graph 251.

As used herein, the EOM 250 is a collection of application programming interfaces (APIs) that enables seeded semantic object models to be extended. For example, the EOM 250 enables a knowledge graph 251 to be built subject to constraints expressed in the customer's semantic object model. Thus, the knowledge graphs 251 are generated by customers (e.g., enterprises or organizations) to create data models of the edge devices 161 a-161 n of an enterprise 160 a-160 n, and the knowledge graphs 251 are input into the EOM 250 for visualizing the data models (e.g., the nodes and links).

The data models describe the assets (e.g., the nodes) of an enterprise (e.g., the edge devices 161 a-161 n) and describe the relationship of the assets with other components (e.g., the links). The data models also describe the schema (e.g., describe what the data is), and therefore the data models are self-validating. For example, the data model may describe the type of sensors mounted on any given asset (e.g., edge device 161 a-161 n) and the type of data that is being sensed by each sensor. A key performance indicator (KPI) framework can be used to bind properties of the assets in the EOM 250 to inputs of the KPI framework. Accordingly, the IoT platform 125 is an extensible, model-driven end-to-end stack including: two-way model sync and secure data exchange between the edge 115 and the cloud 105, metadata driven data processing (e.g., rules, calculations, and aggregations), and model driven visualizations and applications. As used herein, “extensible” refers to the ability to extend a data model to include new properties/columns/fields, new classes/tables, and new relations. Thus, the IoT platform 125 is extensible with regards to edge devices 161 a-161 n and the applications 146 that handle those devices 161 a-161 n. For example, when new edge devices 161 a-161 n are added to a facility 160 a-160 n, the new devices 161 a-161 n will automatically appear in the IoT platform 125 so that the corresponding applications 146 may understand and use the data from the new devices 161 a-161 n.

In some cases, asset templates are used to facilitate configuration of instances of edge devices 161 a-161 n in the data model using common structures. An asset template defines the typical properties for the edge devices 161 a-161 n of a given enterprise 160 a-160 n for a certain type of device. For example, an asset template of a pump includes modeling the pump having inlet and outlet pressures, speed, flow, etc. The templates may also include hierarchical or derived types of edge devices 161 a-161 n to accommodate variations of a base type of device 161 a-161 n. For example, a reciprocating pump is a specialization of a base pump type and would include additional properties in the template. Instances of the edge devices 161 a-161 n in the data model are configured to match the actual, physical devices of the enterprises 160 a-160 n using the templates to define expected attributes of the edge devices 161 a-161 n. Each attribute is configured either as a static value (e.g., capacity is 1000 BPH) or with a reference to a time series tag that provides the value. The knowledge graph 250 can automatically map the tag to the attribute based on naming conventions, parsing, and matching the tag and attribute descriptions and/or by comparing the behavior of the time series data with expected behavior.

The modeling phase includes an onboarding process for syncing the data models between the enterprises 160 a-160 n and the cloud 105. For example, the onboarding process can include a simple onboarding process, a complex onboarding process, and/or a standardized rollout process. The simple onboarding process includes the knowledge graph 250 receiving raw model data from the enterprises 160 a-160 n and running context discovery algorithms to generate the data model. The context discovery algorithms read the context of the edge naming conventions of the edge devices 161 a-161 n and determine what the naming conventions refer to. For example, the knowledge graph 250 can receive “TMP” during the modeling phase and determine that “TMP” relates to “temperature.” The generated data models are then published. The complex onboarding process includes the knowledge graph 250 receiving the raw model data, receiving point history data, and receiving site survey data. The knowledge graph 250 can then use these inputs to run the context discovery algorithms. The generated data models can be edited and then the data models are published. The standardized rollout process includes manually defining standard data models in the cloud 105 and pushing the data models to the enterprises 160 a-160 n.

The IoT layer 205 includes one or more components for device management, data ingest, and/or command/control of the edge devices 161 a-161 n. The components of the IoT layer 205 enable data to be ingested into, or otherwise received at, the IoT platform 125 from a variety of sources. For example, data can be ingested from the edge devices 161 a-161 n through process historians or laboratory information management systems. The IoT layer 205 is in communication with the edge connectors 165 a-165 n installed on the edge gateways 162 a-162 n through network 110, and the edge connectors 165 a-165 n send the data securely to the IoT platform 205. In some embodiments, only authorized data is sent to the IoT platform 125, and the IoT platform 125 only accepts data from authorized edge gateways 162 a-162 n and/or edge devices 161 a-161 n. Data may be sent from the edge gateways 162 a-162 n to the IoT platform 125 via direct streaming and/or via batch delivery. Further, after any network or system outage, data transfer will resume once communication is re-established and any data missed during the outage will be backfilled from the source system or from a cache of the IoT platform 125. The IoT layer 205 may also include components for accessing time series, alarms and events, and transactional data via a variety of protocols.

The enterprise integration layer 210 includes one or more components for events/messaging, file upload, and/or REST/OData. The components of the enterprise integration layer 210 enable the IoT platform 125 to communicate with third party cloud applications 211, such as any application(s) operated by an enterprise in relation to its edge devices. For example, the enterprise integration layer 210 connects with enterprise databases, such as guest databases, customer databases, financial databases, patient databases, etc. The enterprise integration layer 210 provides a standard application programming interface (API) to third parties for accessing the IoT platform 125. The enterprise integration layer 210 also enables the IoT platform 125 to communicate with the OT systems 163 a-163 n and IT applications 164 a-164 n of the enterprise 160 a-160 n. Thus, the enterprise integration layer 210 enables the IoT platform 125 to receive data from the third-party applications 211 rather than, or in combination with, receiving the data from the edge devices 161 a-161 n directly.

The data pipeline layer 215 includes one or more components for data cleansing/enriching, data transformation, data calculations/aggregations, and/or API for data streams. Accordingly, the data pipeline layer 215 can pre-process and/or perform initial analytics on the received data. The data pipeline layer 215 executes advanced data cleansing routines including, for example, data correction, mass balance reconciliation, data conditioning, component balancing and simulation to ensure the desired information is used as a basis for further processing. The data pipeline layer 215 also provides advanced and fast computation. For example, cleansed data is run through enterprise-specific digital twins. The enterprise-specific digital twins can include a reliability advisor containing process models to determine the current operation and the fault models to trigger any early detection and determine an appropriate resolution. The digital twins can also include an optimization advisor that integrates real-time economic data with real-time process data, selects the right feed for a process, and determines optimal process conditions and product yields.

The data pipeline layer 215 may also use models and templates to define calculations and analytics and define how the calculations and analytics relate to the assets (e.g., the edge devices 161 a-161 n). For example, a pump template can define pump efficiency calculations such that every time a pump is configured, the standard efficiency calculation is automatically executed for the pump. The calculation model defines the various types of calculations, the type of engine that should run the calculations, the input and output parameters, the preprocessing requirement and prerequisites, the schedule, etc. The actual calculation or analytic logic may be defined in the template or it may be referenced. Thus, the calculation model can be used to describe and control the execution of a variety of different process models. Calculation templates can be linked with the asset templates such that when an asset (e.g., edge device 161 a-161 n) instance is created, any associated calculation instances are also created with their input and output parameters linked to the appropriate attributes of the asset (e.g., edge device 161 a-161 n).

The data insight layer 220 includes one or more components for time series databases (TDSB), relational/document databases, data lakes, blob, files, images, and videos, and/or an API for data query. When raw data is received at the IoT platform 125, the raw data can be stored as time series tags or events in warm storage (e.g., in a TSDB) to support interactive queries and to cold storage for archive purposes. Data can further be sent to the data lakes for offline analytics development. The data pipeline layer 215 can access the data stored in the databases of the data insight layer 220 to perform analytics, as detailed above.

The application services layer 225 includes one or more components for rules engines, workflow/notifications, KPI framework, insights (e.g., actionable insights), decisions, recommendations, machine learning, and/or an API for application services. The application services layer 225 enables building of applications 146 a-d. The applications layer 230 includes one or more applications 146 a-d of the IoT platform 125. For example, the applications 146 a-d can include a buildings application 146 a, a plants application 146 b, an aero application 146 c, and other enterprise applications 146 d. The applications 146 can include general applications 146 for portfolio management, asset management, autonomous control, and/or any other custom applications. Portfolio management can include the KPI framework and a flexible user interface (UI) builder. Asset management can include asset performance and asset health. Autonomous control can include energy optimization and predictive maintenance. As detailed above, the general applications 146 can be extensible such that each application 146 can be configurable for the different types of enterprises 160 a-160 n (e.g., buildings application 146 a, plants application 146 b, aero application 146 c, and other enterprise applications 146 d).

The applications layer 230 also enables visualization of performance of the enterprise 160 a-160 n. For example, dashboards provide a high-level overview with drill downs to support deeper investigations. Recommendation summaries give users prioritized actions to address current or potential issues and opportunities. Data analysis tools support ad hoc data exploration to assist in troubleshooting and process improvement.

The core services layer 235 includes one or more services of the IoT platform 125. The core services 235 can include data visualization, data analytics tools, security, scaling, and monitoring. The core services 235 can also include services for tenant provisioning, single login/common portal, self-service admin, UI library/UI tiles, identity/access/entitlements, logging/monitoring, usage metering, API gateway/dev portal, and the IoT platform 125 streams.

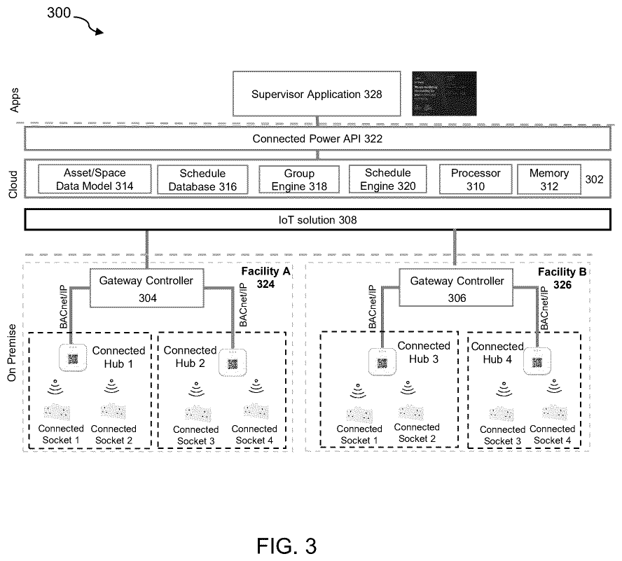

FIG. 3 illustrates a layered architecture of a system 300 for controlling operations of connected sockets, in accordance with an embodiment of the present disclosure. Several connected sockets (alternatively referred as “sockets” or “plug points”) may be installed in different environments, such as residential, office, or industrial environments. The connected sockets may be installed for powering different plug-in assets, such as geysers, luminaires, air purifiers, office printers, refrigerators, microwave oven, vending machines, and other plug-in assets. These plug-in assets consume a certain amount of energy. To facilitate efficient operations, it becomes important to monitor the energy consumption or power usage by these plug-in assets in each facility using a common platform. Each connected socket comprises one or more socket outlets or receptacles. Multiple sockets installed in an area may be connected with a connected hub over a wireless network. The wireless network may be a wireless mesh network. The wireless mesh network uses radio frequency (RF) signals to connect the sockets and the connected hub. It has two layers: one allows each socket to connect directly to its connected hub, and the other layer links all sockets to each other. This forms multiple communication routes between sockets so that messages between the socket and its connected hub may be relayed by other sockets. This allows using an alternative route in case of a blockage in the wireless network. Accordingly, the wireless mesh network may often continue to operate even when a communication route becomes unstable, making it much more reliable than a conventional non-meshed network. Therefore, each socket may be connected with a connected hub present in vicinity. The connected hub can be understood as a network device configured to provide operational instructions such as ON/OFF, LOCK/UNLOCK, and/or like to the connected sockets and receive operational data of the plug-in assets powered using the connected sockets. The operational data may include, but not limited to, current, voltage, and power consumption, time of operation, peak values of power consumption and associated timings, socket temperature, socket health status, alarms raised upon crossing of threshold values, and/or like.

Each connected hub may be connected with a gateway controller. As shown in FIG. 3, connected hub 1 and connected hub 2 are connected with the gateway controller 304 of facility A 324, and connected hub 3 and connected hub 4 are connected with the gateway controller 306 of facility B 326. The facilities illustrated in FIG. 3 are exemplary only and are not limited to facilities A and B. There may be any number of such facilities. The connected hubs 1, 2, 3, and 4 may be connected with the respective gateway controllers 304 and 306 using a wired or wireless connection and may communicate using a suitable protocol, such as BACnet/IP. BACnet is a communication protocol for Building Automation and Control (BAC) networks that use the ASHRAE, ANSI, and ISO 16484-5 standards protocol.

In an embodiment, the gateway controller(s) 304 and 306 may be a cloud connector or a cloud gateway. Each gateway controller(s) 304 and 306 may communicate data of corresponding sockets to a cloud-based server 302 via the network 110. An Internet of Things (IoT) solution 308 running over the cloud-based server 302 may perform required processing of the data of the connected sockets. The IoT solution may also utilize other information, such as an asset/space data model and operational data. Such information may be present over the cloud-based server 302 in one or more storage modules. The asset/space data model may include details of layout of each facility (such as facility A and/or facility B), such as a floor, and position of various plug-in assets on the floor, data related to various assets such as asset identifier, asset type, asset location, and/or like, relationship among the various assets, relationship between the asset and respective facility, and/or like.

The cloud-based server 302 includes a group engine 318, a schedule engine 320, a schedule database 316, and an asset/space data model 314. Additionally, in one or more embodiments, the cloud-based server 302 includes a processor 310 and a memory 312. In certain embodiments, one or more aspects of the cloud-based server 302 (and/or other systems, apparatuses and/or processes disclosed herein) constitute executable instructions embodied within a computer-readable storage medium (e.g., the memory). For instance, in an embodiment, the memory 312 stores computer executable component and/or executable instructions (e.g., program instructions). Furthermore, the processor 310 facilitates execution of the computer executable components and/or the executable instructions (e.g., the program instructions). In an embodiment, the processor 310 is configured to execute instructions stored in the memory 312 or otherwise accessible to the processor 310.

The processor 310 is a hardware entity (e.g., physically embodied in circuitry) capable of performing operations according to one or more embodiments of the disclosure. Alternatively, in an embodiment where the processor 310 is embodied as an executor of software instructions, the software instructions configure the processor 310 to perform one or more algorithms and/or operations described herein in response to the software instructions being executed. In an embodiment, the processor 310 is a single core processor, a multi-core processor, multiple processors internal to the cloud-based server 302, a remote processor (e.g., a processor implemented on a server), and/or a virtual machine. In certain embodiments, the processor 310 is in communication with the memory 312, a group engine 318, a schedule engine 320, a schedule database 316, and an asset/space data model 314 via a bus to, for example, facilitate transmission of data among the processor 310, the memory 312, a group engine 318, a schedule engine 320, a schedule database 316, and an asset/space data model 314. The processor 310 may be embodied in a number of different ways and, in certain embodiments, includes one or more processing devices configured to perform independently. Additionally or alternatively, in one or more embodiments, the processor 310 includes one or more processors configured in tandem via a bus to enable independent execution of instructions, pipelining of data, and/or multi-thread execution of instructions.

The memory 312 is non-transitory and includes, for example, one or more volatile memories and/or one or more non-volatile memories. In other words, in one or more embodiments, the memory 312 is an electronic storage device (e.g., a computer-readable storage medium). The memory 312 is configured to store information, data, content, one or more applications, one or more instructions, or the like, to enable the enterprise data management computer system 302 to carry out various functions in accordance with one or more embodiments disclosed herein. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor, circuitry, an executable component, a thread of instructions, a program, and/or a computer entity.

A software application (shown as supervisor application 328 in FIG. 3) may be provided to communicate with the cloud-based server 302 via the connected power API 322. The software application may provide an interface to the portfolio operator for viewing groups and schedules generated by the group engine 318 and the schedule engine 320 respectively (described in detail below), and providing control command for remotely controlling an operational state of any connected socket.

In an embodiment, the group engine 318 receives data from asset/space data model 314. The asset/space data model 314 may include association between a socket outlet and a plug-in asset in the facility. In an embodiment, the asset/space data model 314 may include details of layout of a particular facility, such as a floor or a zone. The asset/space data model 314 may include position of various assets such as the plug-in assets on the floor or zone in the facility. The asset/space data model 314 may include data related to various assets such as asset identifier, asset type, asset location, and/or like, relationship among the various assets, relationship between the asset and respective facility, and/or like. Each of the plurality of facilities include multiple socket outlets. The group engine 318 creates one or more logical groups of socket outlets based on the received data. In an embodiment, the socket outlets can be grouped together based on at least one of location of plug-in assets or type of the plug-in assets. For instance, in facility A, left receptacle of the connected socket 1 and right receptacle of connected socket 4 are connected to printers. In facility B, left receptacle of the connected socket 2 and left receptacle of connected socket 4 are connected to printers. Hence, the group engine 318 creates a group of 4 socket outlets (i.e. left receptacle of the connected socket 1 of facility A, right receptacle of connected socket 4 of facility A, left receptacle of the connected socket 2 of facility B, and left receptacle of connected socket 4 of facility B) since these socket outlets are connected to printers. Similarly, the group engine 318 may create a group of socket outlets that are connected to refrigerators. Similarly, the group engine 318 may create a group of socket outlets that are connected to heaters. In an embodiment, the created logical groups of socket outlets are displayed to a user (e.g. the portfolio operator) via the supervisor application 328 for review/approval. The group engine 318 receives an input from the user. The input may include modifications or revisions in the one or more groups of socket outlets. Based on the received input, the group engine 318 modifies the one or more groups of socket outlets. In another embodiment, the created one or more logical groups of socket outlets are approved by the user.

In one or more embodiments, the schedule engine 320 creates one or more schedules corresponding to the one or more logical groups of socket outlets. The one or more schedules are created to control the one or more logical groups of socket outlets in an effective manner. The schedules may be created individually or based on created groups. For instance, a schedule is created to switch ON a group of socket outlets connected to printers at 8 am in the facility A and facility B, and switch OFF the group of socket outlets at 6 pm. In an example, if an employee wishes to use a printer at 7 pm, he/she may switch ON a socket outlet corresponding to the printer manually. In an embodiment, the one or more schedules are displayed to the user (e.g. the portfolio operator) via the supervisor application 328 for review/approval. The schedule engine 320 receives an input from the user. The input may include modifications or revisions in the one or more schedules. Based on the received input, the schedule engine 320 modifies the one or more schedules. In another embodiment, the one or more schedules are approved by the user. The one or more schedules are stored in the schedule database 316. In one or more embodiments, the schedule engine 320 splits at least one schedule of the one or more schedules stored in the schedule database 316 into multiple separate schedules for respective facilities. The splitting of schedule is based on a set of socket outlets in the facility from the group of socket outlets.

In one embodiment, the schedule engine 320 communicates with the gateway controllers 304 and 306 or Building Management System (BMS) controllers of the multiple facilities. Based on the splitting of the schedule, the schedule engine transmits one or more control commands such as switch ON/OFF, LOCK/UNLOCK, etc to the one or more logical groups of socket outlets across each facility. The one or more commands are transmitted to the one or more logical groups of socket outlets in a wireless manner via respective connected hubs. The socket outlets are being monitored and controlled at granular level across the plurality of facilities. In another embodiment, the gateway controllers 304 and 306 of the multiple facilities may download the schedules stored in the schedule database 316 and execute the schedules at the respective facilities. For instance, the gateway controller 304 of facility A transmits the one or more control commands to the socket outlets of Facility A only based on the downloaded schedule.

In one or more embodiments, one or more socket outlets transmit characteristics data to the respective gateway controllers 304 and 306 via the connected hubs. The characteristics data includes accumulated energy such as energy consumed by the socket outlet over a period of time (in kilowatt/hour), real power, socket temperature, instantaneous current load, socket status (i.e. whether a socket is online or offline), mode of the socket (indicates whether the socket is ON/OFF, LOCK/UNLOCK), etc. The gateway controller(s) 304 and 306 transmit the characteristics data to the cloud-based server 302 via the network 110. The cloud-based server 302 receives the data and store the data in the memory 312.

In one or more embodiments, the cloud-based server 302 performs analysis of the stored data. For example, the energy consumption of each socket outlet is continuously monitored and reported into the cloud-based server 302 at regular intervals. The temperature of each socket outlet is continuously monitored and reported into the cloud-based server 302 at regular intervals. The cloud-based server 302 generates one or more insights based on the analysis. The one or more insights are displayed to the portfolio operator via the visualization interface (e.g., a dashboard visualization). In one or more embodiments, the visualization interface is configured to allow an end user (e.g., the portfolio operator, the facility operator, an application engineer, a remote support engineer, another end user, etc.) to navigate the visualization interface, access information associated with the socket outlets, access information associated with the one or more insights, and/or troubleshoot issues associated with the socket outlets. The one or more insights may include total energy usage, connectivity, one or more limits, one or more deviations, one or more targets, and/or other data associated with the socket outlets. The one or more insights may include actionable graphical insights for controlling the socket outlets. The one or more insights allow the portfolio operator to review the power profile of the socket outlets. The cloud-based server 302 recommends one or more actions based on the one or more insights. The one or more actions may include changing or modifying the schedule, setting high power limit of the socket outlet, setting low power limit of the socket outlet, temperature limit of the socket outlet, setting alerts, etc. For example, the alerts may be set to any socket outlet and is related to power level rising above or falling below a threshold or the internal socket temperature rising above a particular setpoint, etc. This enables controlling the operational states of the socket outlets remotely and monitoring the energy consumption or power usage of the connected sockets.

In various embodiments, the dashboard visualization is an application that allows the portfolio operator to remotely manage, investigate, and/or resolve issues related to the power usage by the plug-in assets. In an embodiment, the dashboard visualization provides insights related to the power usage by the one or more assets and facilitates setting alerts. Integrating disparate systems into a unified connected system enables a user to interact with the one or more insights in a single view. The dashboard visualization also provides context awareness for the one or more assets and allows a user located remotely from the one or more assets to understand issues. In various embodiments, the dashboard visualization is accessible via a web portal and/or the connected power API 322.

According to various embodiments, cloud analytics is performed to group alerts based on issues and/or to prioritize the issues based on one or more algorithms. In various embodiments, the dashboard visualization provides an issue analysis triage solution that employs one or more data models to automatically present information to facilitate analysis and/or actions related to alerts. As such, according to various embodiments, asset and/or workforce use is optimized, and highest priority issues is presented to a user in an optimal manner. Additionally, according to various embodiments, facility operating and/or maintenance costs are reduced while also improving energy savings, equipment up-time, service operational efficiency, and/or environmental conditions by employing the dashboard visualization. Additionally, by employing the dashboard visualization according to various embodiments, remote triage of faults and/or remote resolution of asset issues is provided. Additionally, according to various embodiments, the dashboard visualization provides a capability to review, manage and/or control the plug-in assets.

In various embodiments, the dashboard visualization facilitates display of graphics and/or other visualizations related to the one or more assets in multiple facilities. For example, in various embodiments, the dashboard visualization provides dynamically generated graphics that show configuration of, relationships between, and/or location of assets in multiple facilities to, for example, enable knowledge associated with remote facilities, and/or performing actions related to issues. In various embodiments, the dashboard visualization facilitates operations and/or scheduling associated with the one or more socket outlets. For example, in various embodiments, the dashboard visualization facilitates temporary or long-term changes to operational modes of the one or more socket outlets that can be made through scheduling changes and/or manual switching to allow for events, seasonal changes, maintenance periods and/or other changes to asset use or operations. In various embodiments, the connected power API 322 is employed to integrate different visualization tools and/or different reporting tools (e.g., via the dashboard visualization). In one or more embodiments, a user-interactive graphical user interface is generated. For instance, in one or more embodiments, the graphical user interface renders a visual representation of the dashboard visualization.

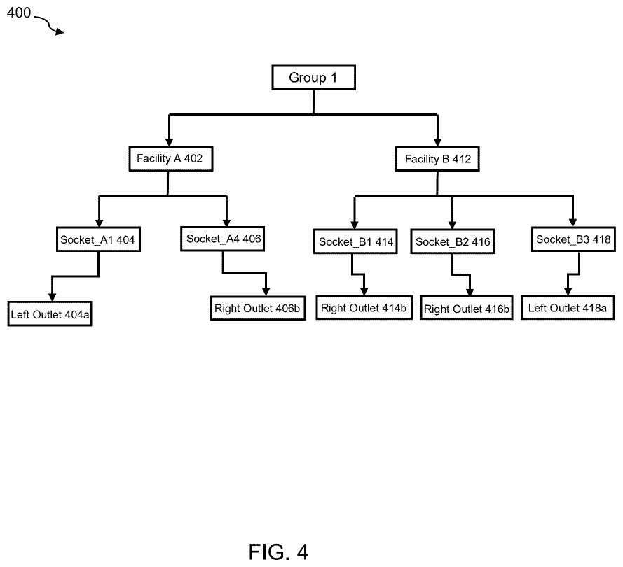

FIG. 4 illustrates an exemplary block diagram of a sample logical group of socket outlets 400, in accordance with one or more embodiments of the present disclosure. The sample group 400 includes Left Outlet 404a of Socket_A1 404 and Right Outlet 406b of Socket_A4 406 of Facility A 402, and Right Outlet 414b of Socket_B1 414, Right Outlet 416b of Socket_B2 416, and Left Outlet 418a of Socket_B3 418 of Facility B 412. In an embodiment, the group engine 318 creates one or more groups based on the properties of the plug-in assets. Accordingly, a plurality of logical groups may be created including socket outlets from the plurality of facilities. In an embodiment, the sample group of socket outlets may be connected to similar type of plug-in assets such as printers. In another embodiment, the sample group of socket outlets are connected to different types of plug-in assets.

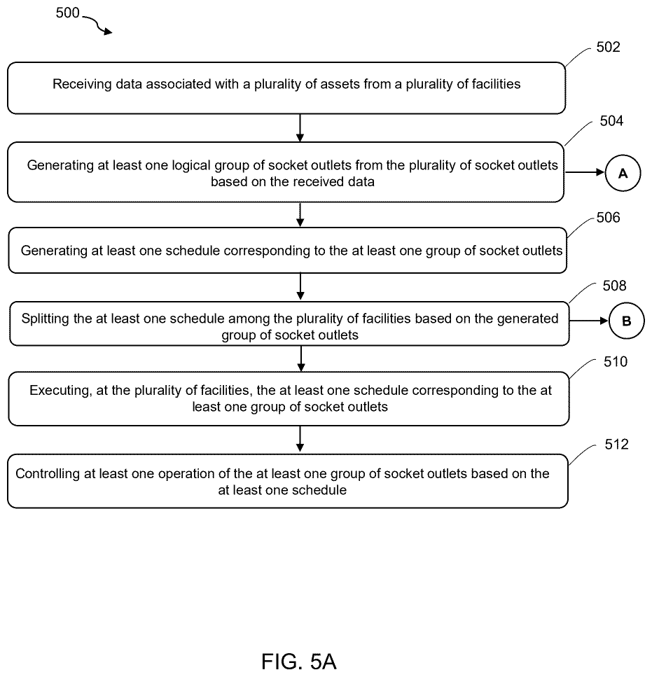

FIG. 5A is a flowchart 500 illustrating a method of controlling the socket outlets, in accordance with one or more embodiments of the present disclosure. The method is executed at the cloud-based server 302 with the processor 310 and the memory 312. The method 500 begins at block 502 that receives data associated with the plurality of plug-in assets from the asset/space data model. At block 504, one or more groups of socket outlets are generated based the data received at block 502. The sample logical group is illustrated at FIG. 4 above. At block 506, one or more schedules are generated corresponding to the one of more groups of socket outlets. At block 508, one or more schedules are split among the plurality of facilities based on the group of socket outlets. At block 510, one or more schedules are executed corresponding to the one of more groups of socket outlets. At block 512, at least one operation of the one or more groups of socket outlets is controlled based on the one or more schedules.

FIG. 5B is a flowchart 520 illustrating a method of controlling socket outlets, in accordance with another embodiment of the present disclosure. The method 520 is partially executed by the cloud-based server 302 and partially executed by the gateway controller of the facility. The method 520 begins at block 522 that receives data associated with the plurality of plug-in assets from the asset/space data model. At block 524, one or more groups of socket outlets are generated based the data received at block 522. The sample logical group is illustrated at FIG. 4 above. At block 526, one or more schedules are generated corresponding to the one of more groups of socket outlets. At block 528, one or more schedules are split among the plurality of facilities based on the group of socket outlets. At block 530, one or more schedules are downloaded from the cloud-based server 302 corresponding to a set of socket outlets from the one of more groups of socket outlets. The set of socket outlets corresponds to the facility. At block 532, at least one schedule corresponding to the set of socket outlets is executed by the gateway controller of the facility. At block 534, at least one operation of the one or more groups of socket outlets is controlled based on the one or more schedules.

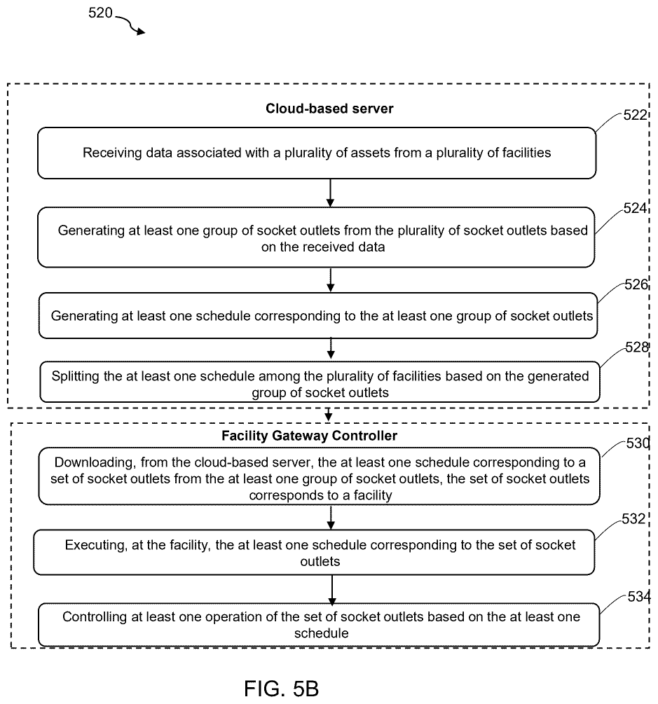

FIG. 6 is a flowchart 600 illustrating example operations of generating a schedule corresponding to the group of socket outlets, in accordance with one or more embodiments of the present disclosure. At block 602, the generated one or more groups of socket outlets are displayed to the user (e.g. the portfolio operator) via the dashboard visualization. At block 604, an input is received from the user corresponding to the generated one or more groups of socket outlets. At block 606, one or more groups of socket outlets are modified by the user based on the input received from the user. At block 608, one or more schedules are generated corresponding to the group of socket outlets.

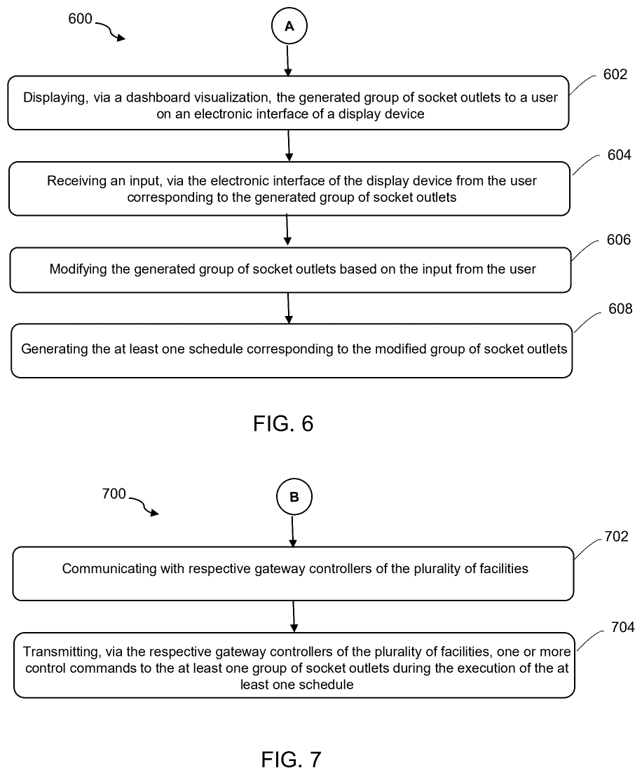

FIG. 7 is a flowchart 700 illustrating example operations of transmitting control commands to the group of socket outlets, in accordance with one or more embodiments of the present disclosure. At block 702, the cloud-based server 302 communicates with gateway controllers of the plurality of facilities. At block 704, the cloud-based server 302 transmits one or more control commands to the set of socket outlets of respective facilities via respective gateway controllers of the plurality of facilities.

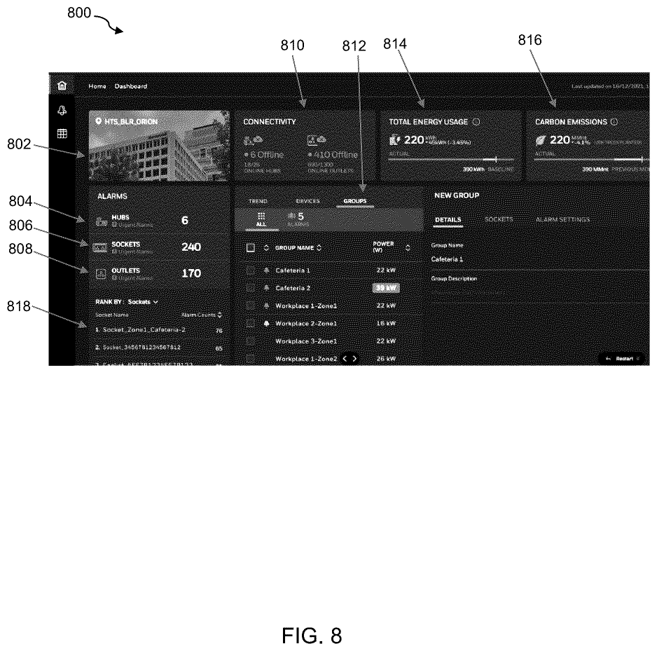

FIG. 8 is an exemplary illustration of dashboard visualization data via the visualization interface 800, in accordance with one embodiment of the present disclosure. The visualization interface 800 presents the one or more insights to the user. The visualization interface 800 presents insight data corresponding to a facility 802. The visualization interface 800 indicates data corresponding to a number of connected hubs 804, a number of sockets 806, and a number of socket outlets 808, and/or like. The visualization interface 800 also indicate connectivity status 810 of connected hubs and socket outlets. The connectivity status 810 indicates total number of connected hubs that are online and/or offline. Similarly, the connectivity status 810 indicates total number outlets that are online and/or offline. The visualization interface 800 further indicates total energy usage 814 (in KWH) of the plug-in assets, carbon emissions 816 corresponding to the plug-in assets, and/or like. It may also display groups of socket outlets such as cafeteria 1, cafeteria 2, workplace 1-zone 1, and so on and the power consumed 812 corresponding to the particular group. The visualization interface 800 also indicates ranking of the sockets 818 based on an alarm count associated with the sockets.

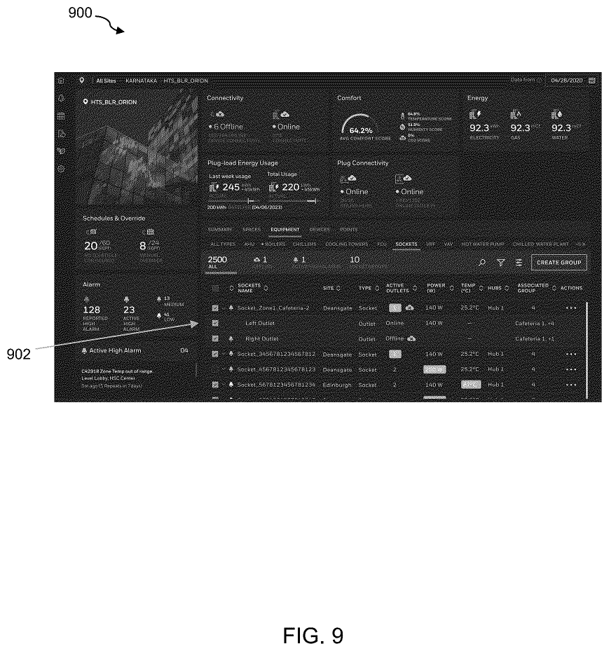

FIG. 9 is an exemplary illustration of the dashboard visualization data via the visualization interface 900, in accordance with another embodiment of the present disclosure. The visualization interface 800 presents the one or more insights to the user. The visualization interface 900 indicates that the group of socket outlets 902 has been created based on the socket outlets across two sites (represented as “Deansgate” and “Edinburgh”). Further, the visualization interface 800 indicates sockets name, type such as socket or socket outlet, number of active outlets corresponding to socket, power consumption by socket and socket outlet, temperature of socket, connected hubs, actions corresponding to the group of socket outlets. Further, the visualization interface 800 presents insight data such as connectivity, comfort, energy consumption, plug-load energy usage, plug connectivity, schedules and overrides, alarm data corresponding to the plurality of groups of socket outlets. Also, new group of socket outlets may be created by user via the visualization interface 900 using “create group” icon. The new group of socket outlets may be created by the user based on the socket outlets across multiple sites.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components can be used in conjunction with the system described herein. Therefore, it is to be understood that the inventions are not to be limited to the specific embodiments disclosed and that modifications and other embodiments are intended to be included within the scope of the appended claims. Moreover, the steps in the method described above can not necessarily occur in the order depicted in the accompanying diagrams, and in some cases one or more of the steps depicted can occur substantially simultaneously, or additional steps can be involved. Although specific terms are employed herein, they are used in a generic and descriptive sense only and not for purposes of limitation.

It is intended that the specification and examples be considered as exemplary only, with a true scope and spirit of the disclosure being indicated by the following claims.

1. A system, comprising:
a cloud-based server comprising:
a processor; and
a memory storing program instructions which, when executed by the processor, cause the processor to:
generate at least one group of socket outlets from a plurality of socket outlets associated with a plurality of facilities, wherein the socket outlets are logically grouped based on data associated with a plurality of assets;
generate at least one schedule corresponding to the at least one group of socket outlets;
split the at least one schedule among the plurality of facilities based on the generated group of socket outlets;
execute, at the plurality of facilities, the at least one schedule corresponding to the at least one group of socket outlets; and
control at least one operation of the at least one group of socket outlets based on the at least one schedule.

2. The system of claim 1, wherein the data comprises at least one of asset data, relationship among the plurality of assets, and relationship between at least one asset of the plurality of assets and at least one facility of the plurality of facilities.

3. The system of claim 1, wherein the memory storing program instructions which, when executed by the processor, further cause the processor to store the at least one schedule in a schedule database.

4. The system of claim 1, wherein the memory storing program instructions which, when executed by the processor, further cause the processor to:
communicate with gateway controllers of the plurality of facilities; and
transmit, via the respective gateway controllers of the plurality of facilities, one or more control commands to the at least one group of socket outlets during the execution of the at least one schedule.

5. The system of claim 4, wherein the one or more control commands include one of a switch ON command or a switch OFF command to operate the at least one group of socket outlets.

6. The system of claim 1, wherein the plurality of socket outlets is wirelessly connected to respective hubs of the plurality of facilities.

7. The system of claim 1, wherein the memory storing program instructions which, when executed by the processor, further cause the processor to:
display, via a dashboard visualization, the generated group of socket outlets to a user on an electronic interface of a display device; and
receive an input, via the electronic interface of the display device from the user corresponding to the generated group of socket outlets.

8. The system of claim 7, wherein the memory storing program instructions which, when executed by the processor, further cause the processor to modify the generated group of socket outlets based on the input from the user.

9. The system of claim 8, wherein the memory storing program instructions which, when executed by the processor, further cause the processor to generate the at least one schedule corresponding to the modified group of socket outlets.

10. A system, comprising:
a gateway controller and a memory storing program instructions which, when executed by the gateway controller, cause the gateway controller to:
receive, from a cloud-based server, at least one schedule corresponding to a set of socket outlets from at least one group of socket outlets, wherein the set of socket outlets is associated with a facility of a plurality of facilities, wherein the cloud-based server is configured to:
generate the at least one group of socket outlets from a plurality of socket outlets associated with the plurality of facilities, wherein the socket outlets are logically grouped based on data associated with a plurality of assets;
generate the at least one schedule corresponding to the at least one group of socket outlets; and
split the at least one schedule among the plurality of facilities based on the generated group of socket outlets;
execute, at the facility, the at least one schedule corresponding to the set of socket outlets; and
control at least one operation of the set of socket outlets based on the at least one schedule.

11. The system of claim 10, wherein the memory storing program instructions which, when executed by the gateway controller, cause the gateway controller to download the at least one schedule corresponding to the set of socket outlets from the cloud-based server.

12. A computer-implemented method, comprising:
at a cloud-based server:
generating at least one group of socket outlets from a plurality of socket outlets associated with a plurality of facilities, wherein the socket outlets are logically grouped based on data associated with a plurality of assets;
generating at least one schedule corresponding to the at least one group of socket outlets;
splitting the at least one schedule among the plurality of facilities based on the generated group of socket outlets;
executing, at the plurality of facilities, the at least one schedule corresponding to the at least one group of socket outlets; and
controlling at least one operation of the at least one group of socket outlets based on the at least one schedule.

13. The computer-implemented method of claim 12, wherein the data comprises at least one of asset data, relationship among the plurality of assets, and relationship between at least one asset of the plurality of assets and at least one facility of the plurality of facilities.

14. The computer-implemented method of claim 12, further comprising storing the at least one schedule in a schedule database.

15. The computer-implemented method of claim 12, further comprising:
communicating with respective gateway controllers of the plurality of facilities; and
transmitting, via the respective gateway controllers of the plurality of facilities, one or more control commands to the at least one group of socket outlets during the execution of the at least one schedule.

16. The computer-implemented method of claim 15, wherein the one or more control commands include one of a switch ON command or a switch OFF command to operate the at least one group of socket outlets.

17. The computer-implemented method of claim 12, wherein the plurality of socket outlets is wirelessly connected to respective hubs of the plurality of facilities.

18. The computer-implemented method of claim 12, further comprising:
displaying, via a dashboard visualization, the generated group of socket outlets to a user on an electronic interface of a display device; and
receiving an input, via the electronic interface of the display device from the user corresponding to the generated group of socket outlets.

19. The computer-implemented method of claim 18, further comprising modifying the generated group of socket outlets based on the input from the user.

20. The computer-implemented method of claim 19, further comprising generating the at least one schedule corresponding to the modified group of socket outlets.
